(19) United States
(12) Patent Application Publication
(10) Pub. No.: US 2017/0140315 A1
(43) Pub. Date: May 18, 2017

(54) MANAGING INCIDENT TICKETS IN A CLOUD MANAGED SERVICE ENVIRONMENT

(71) Applicant: International Business Machines Corporation, Armonk, NY (US)

(72) Inventors: Bin Cao, Rochester, MN (US); David M. Egle, Rochester, MN (US); Daniel L. Hiebert, Pine Island, MN (US); Raymond S. Perry, Rochester, MN (US)

(21) Appl. No.: 14/943,102

(22) Filed: Nov. 17, 2015

(51) Int. Cl. G06Q 10/06

(52) U.S. Cl. CPC G06Q 10/06311

(57) ABSTRACT

An approach for managing incident tickets in a cloud managed service environment is provided. In an embodiment, in response to receipt of an incident ticket, it is determined whether a threshold number of incident tickets similar to the received incident ticket have been answered within a specified time period. This determination may include determining frequencies with which a plurality of previous resolutions applied to the similar incident tickets have been successful. Further, in response to determining that the threshold number of similar incident tickets have been answered, an automated response is provided to the received incident ticket and to subsequently received similar incident tickets, where similar incident tickets are defined as having a same error code or category type. The automated response may comprise a series of one or more previous resolutions to the similar incident tickets in order of the highest frequency of success.

### TECHNICAL FIELD

This invention relates generally to managing incident tickets and, more specifically, to providing an automated response to received incident tickets in a networked computing environment (e.g., a cloud managed service environment).

### BACKGROUND

The networked computing environment (e.g., cloud computing environment) is an enhancement to the predecessor grid environment, whereby multiple grids and other computation resources may be further enhanced by one or more additional abstraction layers (e.g., a cloud layer), thus making disparate devices appear to an end-consumer as a single pool of seamless resources. These resources may include such things as physical or logical computing engines, servers and devices, device memory, and storage devices, among others.

In the typical cloud computing environment, resources are pooled and their availability controlled through virtualization technologies. Cloud managed services, specifically the advanced management of virtualized endpoints, are emerging in the public, private, and hybrid cloud markets as a way to determine that virtualized workloads meet certain operating standards. Cloud managed services may be employed to bring services such as anti-virus, backup, disaster recovery, monitoring, health-check, patch, and security to virtualized machines (VMs) to provide, among other things, stability, security, and performance in a large, heterogeneous network.

During a provisioning process, for example, creating a VM or installing and configuring managed services on a VM within a cloud, errors or failures may occur. When a failure occurs, an ‘incident ticket’ can be raised to a front end system for a (cloud) administrator to handle. The administrator may handle the incident in a number of pre-defined ways, including: abort the task (with rollback), abandon the task (no rollback), skip the process causing a problem, or attempt to fix the problem and retry the failing process.

### SUMMARY

Embodiments described herein provide an approach for managing incident tickets in a cloud managed service environment. In an embodiment, in response to receipt of an incident ticket, it is determined whether a threshold number of incident tickets similar to the received incident ticket have been answered within a specified time period. This determination may include determining frequencies with which a plurality of previous resolutions applied to the similar incident tickets have been successful. Further, in response to determining that the threshold number of similar incident tickets have been answered, an automated response is provided to the received incident ticket and to subsequently received similar incident tickets, where similar incident tickets are defined as having a same error code or category type. The automated response may comprise a series of one or more previous resolutions to the similar incident tickets in order of the highest frequency of success.

A first aspect of the present invention includes a method for managing incident tickets in a managed service environment, the method comprising: receiving an incident ticket; determining whether a threshold number of incident tickets similar to the received incident ticket have been answered within a specified time period; calculating, in response to the threshold having been met, a frequency with which at least one previous resolution applied to at least one similar incident ticket has been successful; ordering the previous resolutions based on the calculated success frequency; and providing at least one automated response to the received incident ticket based on the ordered previous resolutions.

Another aspect of the present invention includes a computer system for managing incident tickets in a managed service environment, the computer system comprising: a memory medium comprising program instructions; a bus coupled to the memory medium; and a processor for executing the program instructions, the instructions causing the system to: receive an incident ticket; determine whether a threshold number of incident tickets similar to the received incident ticket have been answered within a specified time period; calculate, in response to the threshold having been met, a frequency with which at least one previous resolution applied to at least one similar incident ticket has been successful; order the previous resolutions based on the calculated success frequency; and provide at least one automated response to the received incident ticket based on the ordered previous resolutions.

Yet another aspect of the present invention includes a computer program product for managing incident tickets in a managed service environment, the computer program product comprising a computer readable storage device, and program instructions stored on the computer readable storage device, to: receive an incident ticket; determine whether a threshold number of incident tickets similar to the received incident ticket have been answered within a specified time period; calculate, in response to the threshold having been met, a frequency with which at least one previous resolution applied to at least one similar incident ticket has been successful; order the previous resolutions based on the calculated success frequency; and provide at least one automated response to the received incident ticket based on the ordered previous resolutions.

Still yet another aspect of the present invention includes a method for deploying a system for managing incident tickets in a managed service environment comprising: providing a computer infrastructure being operable to perform the processes of: receiving an incident ticket; determining whether a threshold number of incident tickets similar to the received incident ticket have been answered within a specified time period; calculating, in response to the threshold having been met, a frequency with which at least one previous resolution applied to at least one similar incident ticket has been successful; ordering the previous resolutions based on the calculated success frequency; and providing at least one automated response to the received incident ticket based on the ordered previous resolutions.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 depicts an environment in which an incident ticket may be processed according to an embodiment of the present invention;

FIG. 5 depicts an incident ticket management solution for a cloud managed service environment according to an embodiment of the present invention;

FIG. 6 depicts a progressive-answer solution used in the incident ticket management solution of FIG. 5 according to an embodiment of the present invention; and

FIG. 7 depicts a process flowchart according to an embodiment of the present invention.

The drawings are not necessarily to scale. The drawings are merely schematic representations, not intended to portray specific parameters of the invention. The drawings are intended to depict certain embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which exemplary embodiments are shown. It will be appreciated that this disclosure may be embodied in many different forms and should not be construed as limited to the embodiments set forth herein. Rather, these illustrative embodiments are provided so that this disclosure will be thorough and complete and will fully convey the scope of this disclosure to those skilled in the art. In the description, details of well-known features and techniques may be omitted to avoid unnecessarily obscuring the presented embodiments.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, approaches for managing incident tickets in a cloud managed service environment are provided. In an embodiment, in response to receipt of an incident ticket, it is determined whether a threshold number of incident tickets similar to the received incident ticket have been answered within a specified time period. This determination may include determining frequencies with which a plurality of previous resolutions applied to the similar incident tickets have been successful. Further, in response to determining that the threshold number of similar incident tickets have been answered, an automated response is provided to the received incident ticket and to subsequently received similar incident tickets, where similar incident tickets are defined as having a same error code or category type. The automated response may comprise a series of one or more previous resolutions to the similar incident tickets in order of the highest frequency of success.

The inventors of the present invention have discovered that administrators for cloud managed services may become overwhelmed when dealing with many automatically created incident tickets, for example, for multiple failure points on each provision for multiple managed services. Accordingly, embodiments of the present invention provide an adaptive system and method for automatically answering incident tickets based on a number of variables regarding an incident tickets problem including, but not limited to: regularity of a problem (e.g., frequency threshold over time), commonality of a problem's resolution in previous circumstances, and a problem's ability to resolve itself from previous solutions.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

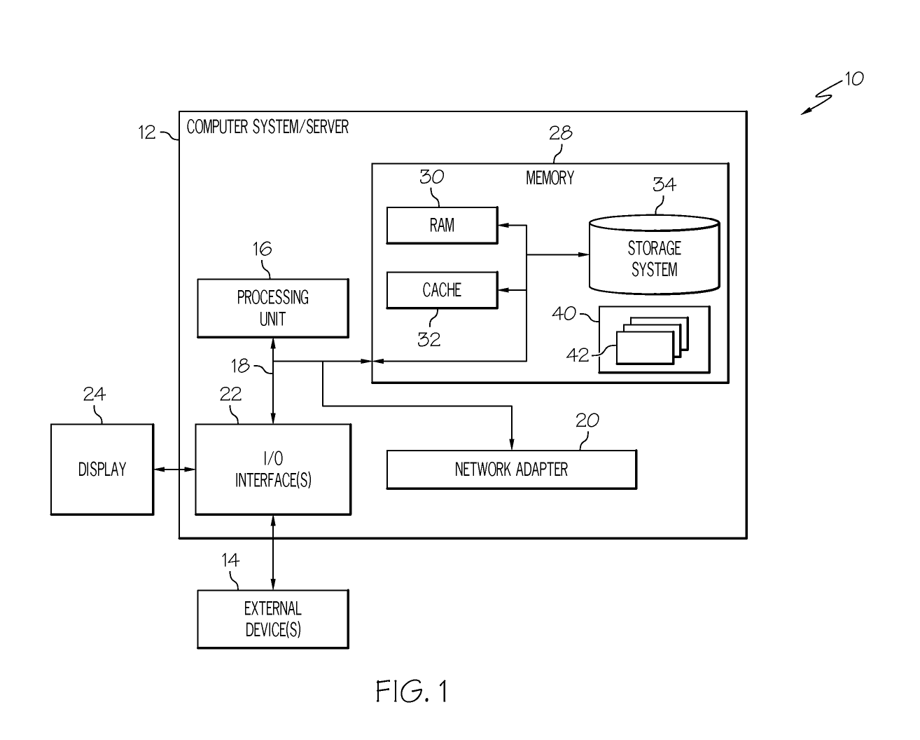

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

Further referring to FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

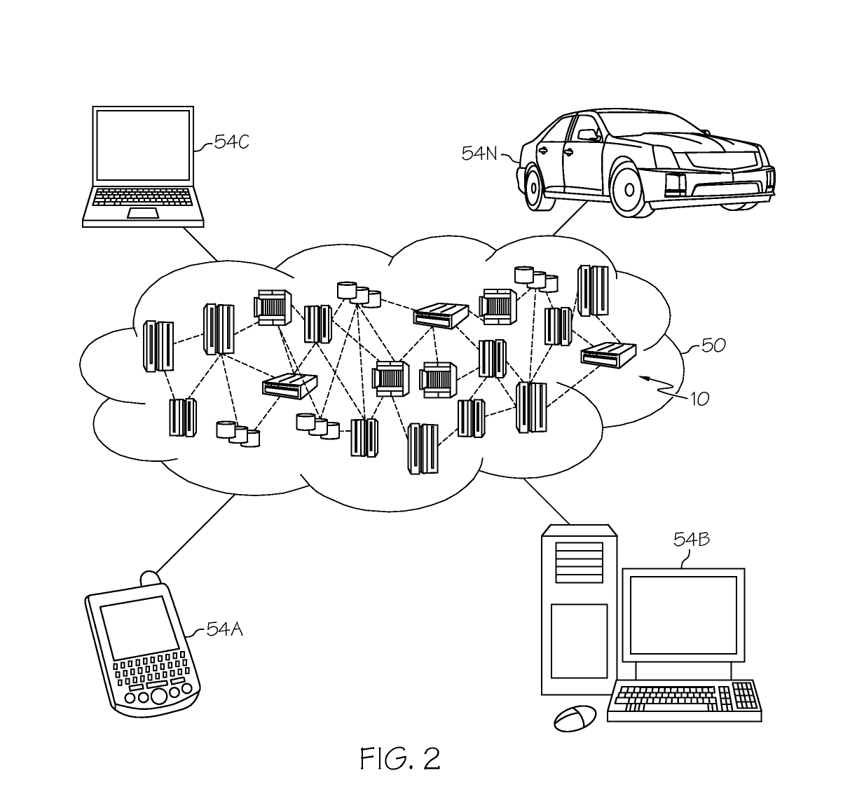

Referring now to FIG. 2, illustrative cloud computing environment 50 is depicted. Cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

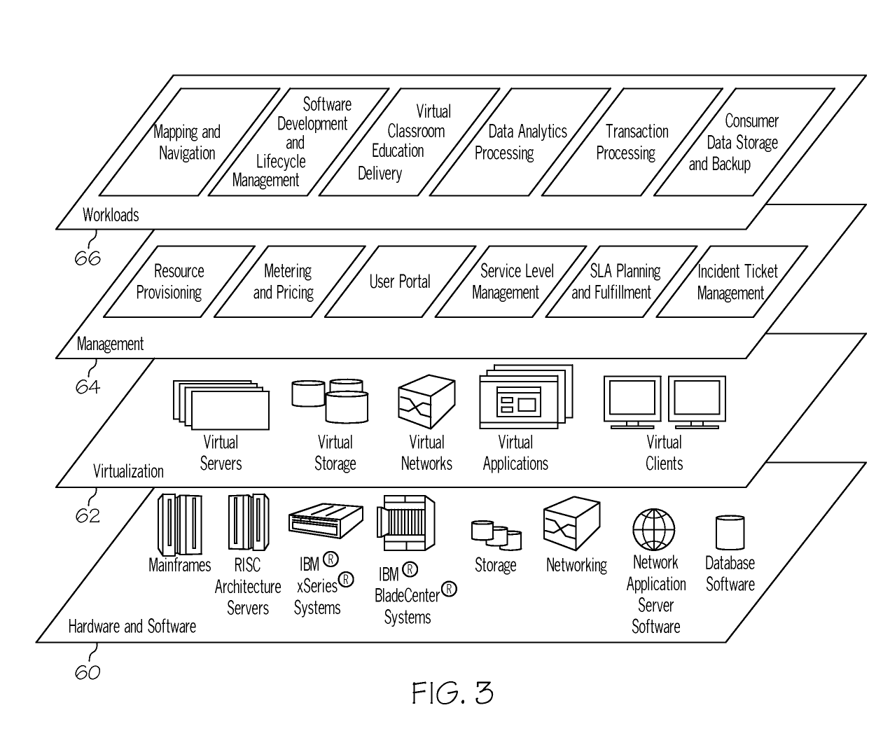

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes. In one example, IBM® zSeries® systems and RISC (Reduced Instruction Set Computer) architecture based servers. In one example, IBM pSeries® systems, IBM System x® servers, IBM BladeCenter® systems, storage devices, networks, and networking components. Examples of software components include network application server software. In one example, IBM WebSphere® application server software and database software. In one example, IBM DB2® database software. (IBM, zSeries, pSeries, System x, BladeCenter, WebSphere, and DB2 are trademarks of International Business Machines Corporation registered in many jurisdictions worldwide.)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. Consumer portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA. Further shown in management layer is incident ticket management, which represents the functionality that is provided under the embodiments of the present invention.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and consumer data storage and backup. As mentioned above, all of the foregoing examples described with respect to FIG. 3 are illustrative only, and the invention is not limited to these examples.

It is understood that all functions of the present invention as described herein typically may be performed by the incident tickets management functionality (of management layer 64, which can be tangibly embodied as modules of program code 42 of program/utility 40 (FIG. 1). However, this need not be the case. Rather, the functionality recited herein could be carried out/implemented and/or enabled by any of the layers 60-66 shown in FIG. 3.

It is reiterated that although this disclosure includes a detailed description on cloud computing, implementation of the teachings recited herein are not limited to a cloud computing environment. Rather, the embodiments of the present invention are intended to be implemented with any type of networked computing environment now known or later developed.

In general, embodiments of the present invention provide a system and method for automatically managing and answering incident tickets of an identified type once a certain number of incident tickets of that type occur for a given problem or problem category over a given period of time, as determined by an administrator-set threshold. Several advantages are provided by embodiments of the present invention. For example, incident tickets may be automatically answered instead of queued for an administrator to personally handle in the event that a high number of the same types of incident tickets are entering a cloud managed service environment. This may result in faster resolution times and prevent administrators from being overwhelmed with duplicate incident tickets. Furthermore, administrators and/or developers may be notified of prevalent problems that might be indicative of a more serious issue.

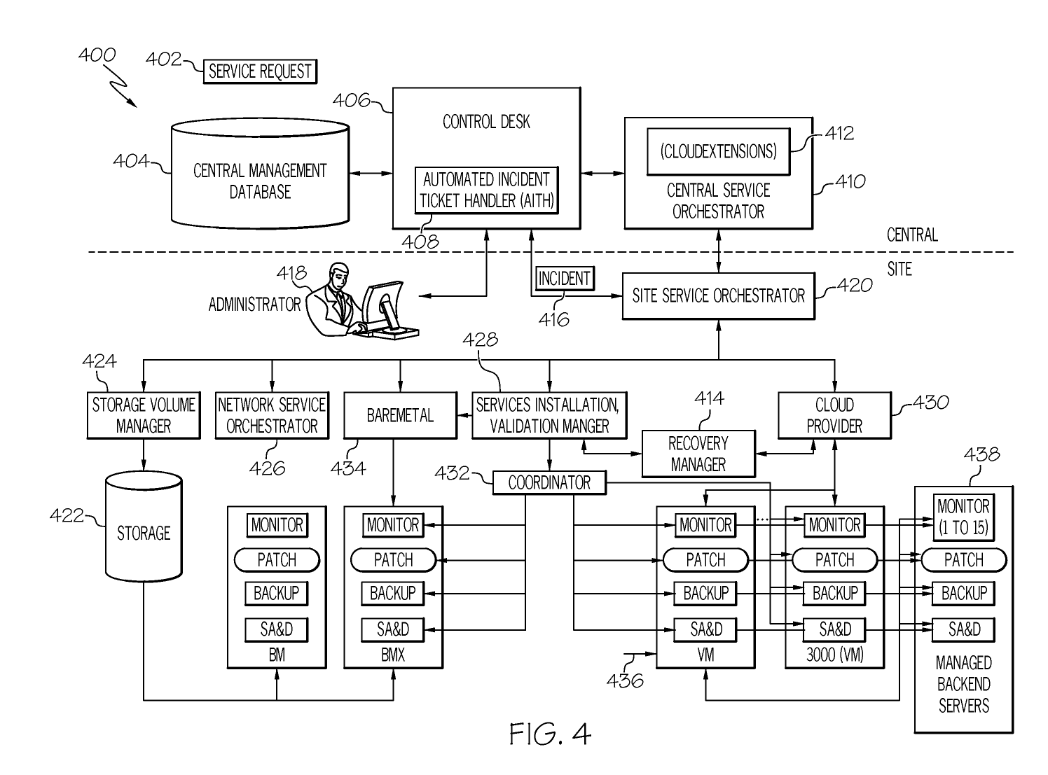

Referring now to FIG. 4, an environment in which an incident ticket may be processed according to an embodiment of the present invention is shown. Service request 402 may be received at control desk 406 (e.g., IBM Smart Cloud Control Desk (SCCD)) of incident ticket management system 400, which, in an embodiment of the present invention, comprises Automated Incident Ticket Handler (AITH) 408. In some embodiments, control desk 406 may be in communication with a central management database 404. Central management database 404 may be used to store service requests 402, previously answered incident tickets, and/or records of previous incident ticket resolutions, as will be further discussed below.

In some embodiments of the present invention, AITH 408 can be embodied as modules of program code 42 of program/utility 40 (FIG. 1). AITH 408 may be configured to carry out one or more process steps of the present invention, as will be discussed in further detail below. Control desk 406 may be further configured to gather information from central management database 404, and send such information to central service orchestrator 410. At central service orchestrator 410, cloud extensions 412 extend service request 402, with information received from central management database 404, and composes a message for site service orchestrator 420. Central service orchestrator 410 is further configured to send messages comprising service request 402 to site service orchestrator 420.

In any case, site service orchestrator 420 may process service request 402 and open incident ticket 416 if a problem is detected. In embodiments of the present invention, incident ticket 416 may be routed to control desk 406 for handling by AITH 408 or an administrator 418 (e.g., an IT team). AITH 408 may process back on site service orchestrator 420 depending on how incident ticket 416 is responded to (e.g., abort, retry, ignore, abandon).

Methods of handling incident ticket 416, for example, by administrator 418, are generally understood in the art and therefore will not be discussed here at length. Furthermore, methods of detecting if there is a problem and an incident ticket 416 should be opened are generally understood and will not be discussed here at length. As way of a non-limiting illustrative example, FIG. 4 depicts a general overview in which site service orchestrator 420 coordinates and monitors various managers and servers/systems of an IT cloud managed service system. For example, site service orchestrator 420 may control network service orchestrator 426, storage 422 through storage volume manager 424, and servers through services installation and validation manger 428 and cloud provider 430 for virtual server management. In one instance, services installation and validation manger 428 may operate controller 432 which can control one or more baremetal servers 434 and/or virtual machines 436. Virtual machines 436 may be monitored in part on servers such as managed backend servers 438. Services installation and validation manger 428 and cloud provider 430 may also be in communication with recovery manager 414. If for example, site service orchestrator 420 detects a problem on any of storage 422, storage volume manager 424, control network service orchestrator 426, validation manger 428, cloud provider 430, controller 432, baremetal servers 434, virtual machines 436, or managed backend servers 438, incident ticket 416 may be opened. The infrastructure described here is for illustrative purposes only and not intended to be limiting. It will be appreciated that other infrastructure and methodologies for incident tickets management and handling in a cloud computing environment are generally known and may be employed within embodiments of the present invention.

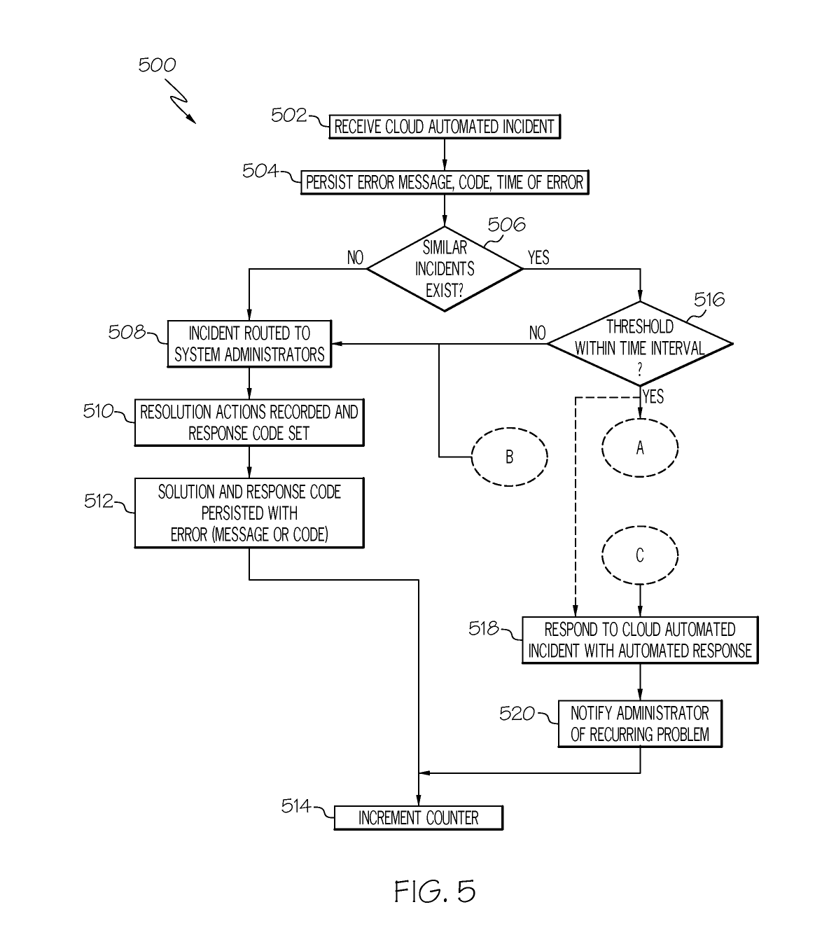

Referring now to FIG. 5, with reference to FIG. 4, incident ticket management solution 500 for a cloud managed service environment by Automated Incident Ticket Handler (AITH) 408 according to illustrative embodiments of the present invention is shown. In one embodiment, at process 502 control desk 406 (e.g., a smart cloud control desk) creates or receives an incident ticket. At process 504, AITH 408 analyzes the incident to determine identifying information indicative of a problem, such as, but not limited to, an error message, code, or time of error. AITH 408 may create a record or database entry of known problems in response to, and in order to further identify a recurring error message or code, or a frequent error message or code during a time of error.

At process 506, AITH 408 determines whether an incident ticket similar to the received incident ticket has been answered by administrators in the past. A similar incident ticket may be an incident ticket having, for example, a same or similar error code, a same or similar error message, a same or similar time of error, etc. In the event that AITH 408 finds no similar previously answered incident ticket, AITH 408 releases the incident ticket to administrator 418 at process 508 where the incident ticket is routed to system administrators. A system administrators may resolve the incident ticket (e.g., abort, abandon, skip, fix, or retry). In response to this resolution by an administrator, at process 510, AITH 408 or control desk 406 records resolution actions and sets a response code for the response. A success or failure of resolution actions may also be recorded by AITH 408 or control desk 406. In some embodiments, AITH 408 or control desk 406 may also record failed resolution actions to eliminate blind alleys in subsequent responses to similar incident tickets. AITH 408 records/stores the solution or resolution and response code with the error (message or code) (e.g., in a table or database). AITH 408 or control desk 406 may also record/store a time stamp with this entry to determine, for example, when or how often a particular error occurs. At process 512, AITH 408 or control desk 406 instructs a system to persist the solution and response code in response to the error message or code. Lastly, at process 514, AITH 408 or control desk 406 may increment a counter to indicate a number of times (C1) that an incident ticket having a particular error message or code has been answered. In some embodiments, C1 may be over a particular time interval.

In the event that AITH 408 finds a similar previously answered incident ticket, AITH 408 proceeds to determine whether AITH 408 and administrators have answered a threshold (T1) number of incident tickets similar to the received incident ticket within a specified time period (Z1). For example, in one embodiment, an administrator may set a threshold incident ticket value (T1) and time interval (Z1) for AITH 408. In some embodiments, AITH 408 may also adjust threshold T1 and Z1, for example, to remove old or obsolete previous similar incident tickets. Referring back to process 512, for each type of incident ticket class (e.g., classified by error code/message, or a general classifier), every time an administrator or AITH 408 answers an incident ticket, AITH 408 or control desk 406 may store the ticket's information (e.g., error code, error message, resolution code, any automated steps taken to solve the problem, the time of error, etc.) in a database or table. In process 516, AITH 408 may retrieve this information to determine if an administrator or AITH 408 has answered at least T1 similar incident tickets over a time interval of Z1.

In some embodiments, administrators may set a time interval of Z1 in order to distinguish between a persistent error and merely an intermittent error, where it may be desirable to initiate automatic responses in the case of the first, but not the latter. For example, if administrator A works one day and answers X incident tickets, and administrator B works the next day and answers T1-X incident tickets, it would be desirable to limit Z1 to one day because neither administrator knows about the other's activities or how prevalent a particular error has become in the system. In another example, if error Y occurs 50 times within the span of a year, error Y should not be automatically answered, but rather individually addressed by an administrator. But if error Y occurs 50 times over the course of 3 days, automatically answering error Y and notifying an administrator of the recurring problem may be the most efficient use of time and resources.

In some embodiments, a similar incident ticket may be any incident ticket having a same error code or error message as a received incident ticket. In other embodiments, a similar incident ticket may further include any incident ticket that has a similar error code or error message, such as having a shared ‘category’ type, as a received incident ticket (e.g., two different errors for provisioning two different services may be categorized together by virtue of both being categorized as provisioning errors). In still further embodiments, a ‘smart’ system may examine an error message and determine similarities to other errors (e.g., based on key-words, a crash-log, a time of error).

In the event that administrators and AITH 408 have answered less than T1 number of incident tickets similar to the received incident ticket within the specified time period Z1, the received incident ticket is routed to system administrators, as discussed above in process 508 and answered and resolved by administrators of an IT team.

However, in the event that administrators and AITH 408 have answered T1 or more than T1 number of incident tickets similar to the received incident ticket within the specified time period Z1, then, at process 518, AITH 408 generates an automatic answer to the received incident ticket. In some embodiments, this automatic answer may be based on an answer and resolution employed by an administrator on a previous, similar incident ticket (e.g., a most numerous answer or resolution response). For example, AITH 408 may retrieve a resolution from a list or database of previous incident tickets (comprising error code, error message, resolution code, any automated steps taken to solve the problem, the time of error, etc.). AITH 408 may further set an auto-answer action for any subsequent incident tickets received having the same error code/message or category within time Z1.

Furthermore, in some embodiments, even if AITH 408 automatically answers an incident ticket, AITH 408 may notify an administrator of the incident at process 520 because, for example, reaching an auto-answer threshold may indicate a recurring problem which should be reviewed by an administrator. AITH 408 may send such notification through email or an additional recurring problem notification incident ticket.

In still further embodiments, when a burst of many similar requests are received in a short time (e.g., 1000 requests in 10 minutes) AITH 408 may automatically temporarily block a majority of the requests (e.g., 95%) while permitting a few requests (e.g., 5% or 1 to 50 requests) to be routed to system administrators at 518. For example, AITH 408 may be configured to permit a sufficient number of requests to be answered by a set of administrators so as to reach threshold T1. This permits the system to build a set of resolutions which AITH 408 may employ in subsequent automatic answers to the remaining requests after threshold T1 is reached. In yet other embodiments, an administrator may determine that a response to a recurring incident/error should be automated (e.g., if the administrator has seen the same error 10 times and resolved it 10 times). Threshold T1 may therefore be set for a particular to equal, for example, the number of recurring incident tickets already answered.

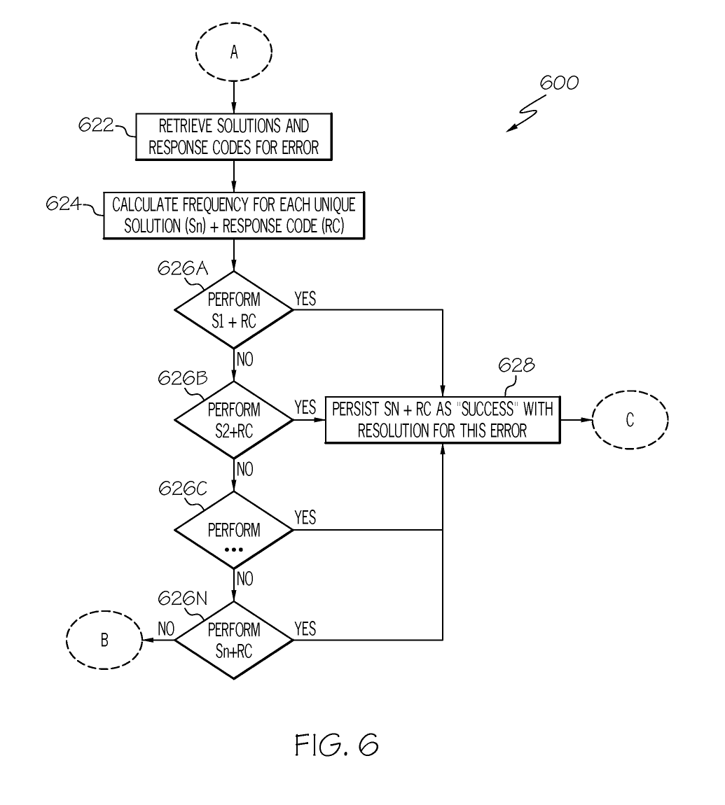

Referring now to FIG. 6, with reference to FIGS. 5 and 4, in the event that administrators and AITH 408 have answered T1 or more than T1 number of incident tickets similar to the received incident ticket within the specified time period Z1, at process 516 of FIG. 5, AITH 408 may apply a set of resolutions to the incident ticket in progressive-answer solution 600. The processes of progressive-answer solution 600 represent a preferred embodiment of the present invention, however, in some embodiments, for example as discussed above with respect to processes 516 through to 518, the processes of progressive-answer solution 600 it may not be included.

At process 622, AITH 408 retrieves resolution solutions and response codes, for example from a table or database, having a same or similar error code or message as the received incident ticket. Resolution solutions may include feedback showing whether a previous resolution solution was a success or a failure. As discussed above in process 510, when an administrator answers and resolves an incident ticket, AITH 408 or control desk 406 stores solution/resolution and response codes with an error message or code. AITH 408 may retrieve from the solution/resolution table one or more previous resolutions for an error code (e.g., how a similar incident ticket has been resolved the last T1 times).

At process 624, AITH 408 calculates a success frequency for each unique solution (Sn) and response code (RC) of the retrieved previous resolutions for the error code. In some embodiments, AITH 408 may determine the frequency of success, for example, by calculating, based on the retrieved previous resolutions, including solution success or failure, which solutions most often resulted in a successful resolution of the error during time TZ. In other embodiments, AITH 408 may determine the frequency of success, for example, by determining which solutions most recently resulted in a successful resolution of the error. In other embodiments, AITH 408 may use a weighted average of success and recentness. In any case, AITH 408 may distribute the resolutions according to their calculated frequency (e.g., in an ordered list of possible solutions). In some embodiments, AITH 408 may truncate the list to only a top number of candidate solutions. For example, in some embodiments, an administrator may configure AITH 408 to create a list for attempting a top 5 or top 5% of resolutions (prior to forward to an administrator as discussed below).

In processes 626A-N, starting with the solution having the highest success frequency, AITH 408 presents or performs automated solutions and response codes. For example, if a first automated solution is unsuccessful at process 626A, AITH 408 attempts a second automated solution at process 626B, and so on through process 626N. If an automated solution is a success, the incident ticket is resolved and AITH 408 records the successful resolution as successful at process 628. A resolution that is recorded as successful for a given error may be given priority at process 624 and placed in an ordered list of possible solutions before other frequency-based solutions. In the event of a successful resolution, AITH 408 returns to the process depicted in FIG. 5, having responded to the cloud automated incident ticket with the series of automated responses outlined above and summarized in process 518.

If all ordered solutions of processes 626A-N are exhausted, AITH 408 may route the incident ticket to a system administrator at process 508 (FIG. 5) for processing by an administrator as discussed above. This routed ticket may further include a list of attempted and failed resolutions so that the administrator knows what solutions have already been attempted. In some other embodiments, an administrator may configure AITH 408 to forward the incident ticket to an administrator if, for example, no prior resolution has worked successfully and all remaining resolutions have worked less than “W” times.

In some embodiments, AITH 408 may note attempted and failed resolutions (e.g., in a database or table). AITH 408 may negatively weight resolutions that have been attempted and failed over several incident tickets in calculating success frequency at process 624. AITH 408 may also mark for exclusion such failed resolutions from subsequent automated answers. In other embodiments, AITH 408 may filter failed resolutions out of success frequency list over time as new, more successful resolutions are found and used multiple times, and a time period TZ shifts.

### Illustrative Example

The above system and process will be better understood through the following illustrative example of an embodiment of the present invention in use.

In this example, Client A attempts to provision a Linux virtual machine (VM) within a cloud managed service environment. The VM provisions fine, but fails attempting to register with a Domain Name System (DNS) server. Client A makes a service request, which prompts a control desk for a cloud managed service to issue an incident ticket having an error code 0x0001. Administrators have answered similar incident tickets having the same error code 20 times in the last two days; this may indicate that the failure to register the DNS server is symptomatic of a larger problem.

Of the previous twenty times error code 0x0001 was answered, 3 times administrators found that the IP address of the new endpoint was already registered in the DNS server, and resolved the problem by running program “ABC” to remove the DNS entries for the IP addresses, and then allowed the process to RETRY and complete. The other 17 times, administrators found that a route was not being added correctly to the routing table, so the VM could not contact the DNS server. The administrators ran program “DEF” on the endpoint to add the route, and then allowed the process to RETRY and complete.

The control desk gathered this information in a system table as follows:

| | Error | | |
|---|---|---|---|
| Error | Code | ERROR description | Resolution |
| 3 | 0x0001 | DNS registration of IP | call “ABC” -ip w.x.y.z; |
| entries | | address w.x.y.z failed | RETRY |
| 17 | 0x0001 | DNS registration of IP | call “DEF” -route a.b.c.d; |
| entries | | address w.x.y.z failed | RETRY |

Assume that an administrator has set a threshold for automated responses to incident tickets at 20 similar incident tickets in 48 hours. Therefore, with the receipt of Client A's incident ticket, the threshold has been reached for incident tickets having error code 0x0001. Consequently, the reached threshold prompts Automated Incident Ticket Handler (AITH) to attempt to automatically answer Client A's incident ticket.

AITH determines from the table that “DEF”+RETRY was previously successful 17 times (85% of the time) and “ABC”+RETRY was previously successful 3 times (15% of the time). AITH ranks these possible solutions: first “DEF”+RETRY, then “ABC”+RETRY. AITH first attempts to automatically answer Client A's incident ticket by running program “DEF” and then allowed the process to RETRY, at which point the suspended process attempts to continue. If the process fails again with the same error, AITH attempts to automatically answer Client A's incident ticket by calling “ABC” and then allows the process to RETRY and continue. If this also fails, and since all previous resolutions have been exhausted, the ticket remains open. AITH then returns the ticket to an administrator to handle.

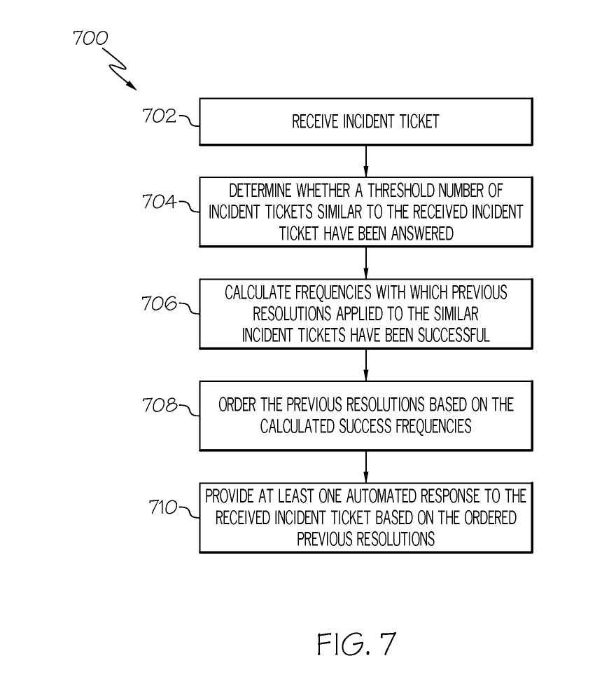

Referring now to FIG. 7, a process flowchart 700 for managing incident tickets in a managed service environment according to embodiments is shown. At process 702, an incident ticket is received. At process 704, whether a threshold number of incident tickets similar to the received incident ticket have been answered within a time period is determined. At process 706, a frequency with which at least one previous resolution applied to at least one similar incident ticket has been successful is calculated in response to the threshold having been met. At process 708, the previous resolutions are ordered based on the calculated success frequency. At process 710, at least one automated response is provided to the received incident ticket based on the ordered previous resolutions.

Process flowchart 700 of FIG. 7 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

While shown and described herein as an incident ticket management solution in a cloud managed service environment, it is understood that the invention further provides various alternative embodiments. For example, in one embodiment, the invention provides a computer-readable/useable medium that includes computer program code to enable a computer infrastructure to provide incident ticket management functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide incident ticket management functionality in a cloud managed service environment. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for managing incident tickets in a cloud managed service environment. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A method for managing incident tickets in a managed service environment, the method comprising:
receiving an incident ticket;
determining whether a threshold number of incident tickets similar to the received incident ticket have been answered within a specified time period;
calculating, in response to the threshold having been met, a frequency with which at least one previous resolution applied to at least one similar incident ticket has been successful;
ordering the previous resolutions based on the calculated success frequency; and
providing at least one automated response to the received incident ticket based on the ordered previous resolutions.

2. The method of claim 1, the method further comprising:
routing, in response to a determination that the threshold has not been met, the incident ticket to a human system administrator; and
recording a solution technique used by the system administrator to resolve the incident ticket.

3. The method of claim 1, the method further comprising:
applying each of the previous resolutions according to the order until the incident ticket is resolved; and
routing, in response to each of the previous resolutions being applied and failing, the incident ticket to a human system administrator.

4. The method of claim 3, the method further comprising recording a successful resolution of the ordered previous resolutions and assigning the successful resolution a priority designation.

5. The method of claim 1, wherein a similar incident ticket has at least one of: a same error code, a same type of error message, or a same category type, as the received incident ticket.

6. The method of claim 1, the method further comprising sending an administrator an incident ticket indicating an error of the received incident ticket is a recurring error.

7. The method of claim 1, wherein the threshold number of incident tickets and the time period is set by a system administrator.

8. A computer system for managing incident tickets in a managed service environment, the computer system comprising:
a memory medium comprising program instructions;
a bus coupled to the memory medium; and
a processor for executing the program instructions, the instructions causing the system to:
receive an incident ticket;
determine whether a threshold number of incident tickets similar to the received incident ticket have been answered within a specified time period;
calculate, in response to the threshold having been met, a frequency with which at least one previous resolution applied to at least one similar incident ticket has been successful;
order the previous resolutions based on the calculated success frequency; and
provide at least one automated response to the received incident ticket based on the ordered previous resolutions.

9. The computer system of claim 8, further comprising program instructions to:
route, in response to a determination that the threshold has not been met, the incident ticket to a human system administrator; and
record a solution technique used by the system administrator to resolve the incident ticket.

10. The computer system of claim 8, further comprising program instructions to:
apply each of the previous resolutions according to the order until the incident ticket is resolved; and
route, in response to each of the previous resolutions being applied and failing, the incident ticket to a human system administrator.

11. The computer system of claim 10, further comprising program instructions to record a successful resolution of the ordered previous resolutions and assign the successful resolution a priority designation.

12. The computer system of claim 8, wherein a similar incident ticket has at least one of: a same error code, a same type of error message, or a same category type, as the received incident ticket.

13. The computer system of claim 8, further comprising program instructions to send an administrator an incident ticket indicating an error of the received incident ticket is a recurring error.

14. The computer system of claim 8, wherein the threshold number of incident tickets and the time period is set by a system administrator.

15. A computer program product for managing incident tickets in a managed service environment, the computer program product comprising a computer readable storage device, and program instructions stored on the computer readable storage device, to:
receive an incident ticket;
determine whether a threshold number of incident tickets similar to the received incident ticket have been answered within a specified time period;
calculate, in response to the threshold having been met, a frequency with which at least one previous resolution by applied to at least one similar incident ticket has been successful;
order the previous resolutions based on the calculated success frequency; and
provide at least one automated response to the received incident ticket based on the ordered previous resolutions.

16. The computer program product of claim 15, further comprising program instructions to:
route, in response to a determination that the threshold has not been met, the incident ticket to a human system administrator; and
record a solution technique used by the system administrator to resolve the incident ticket.

17. The computer program product of claim 15, further comprising program instructions to:
apply each of the previous resolutions according to the order until the incident ticket is resolved; and
route, in response to each of the previous resolutions being applied and failing, the incident ticket to a human system administrator.

18. The computer program product of claim 17, further comprising program instructions to record a successful resolution of the ordered previous resolutions and assign the successful resolution a priority designation.

19. The computer program product of claim 15, wherein a similar incident ticket has at least one of: a same error code, a same type of error message, or a same category type, as the received incident ticket.

20. The computer program product of claim 15, further comprising program instructions to send an administrator an incident ticket indicating an error of the received incident ticket is a recurring error.
